(19) United States
(12) Patent Application Publication
(10) Pub. No.: US 2016/0145456 A1
(43) Pub. Date: May 26, 2016

(54) HYDROPHILIC COATINGS FORMED BY ATMOSPHERIC CO2 REACTION

(71) Applicant: EMPIRE TECHNOLOGY DEVELOPMENT LLC, Wilmington, DE (US)

(72) Inventor: Angele SJONG, Louisville, CO (US)

(21) Appl. No.: 14/898,369

(22) PCT Filed: Jun. 13, 2013
(86) PCT No.: PCT/US13/45555

§ 371 Date: Dec. 14, 2015

(51) Int. Cl. C09D 125/18; B05D 3/04; B05D 5/00

(52) U.S. Cl. CPC C09D 125/18; B05D 5/00; B05D 3/0453

(57) ABSTRACT

Hydrophilic coating compositions and methods to make and use the compositions are disclosed. The compositions include a polymer comprising guanidinyl, amidinyl, hydroxyalkylaminoalkyl, or dihydroxyalkylamino alkyl functional groups. The functional groups react with atmospheric CO₂ to form ionic or polyelectrolytic groups, thus transforming a coated surface from hydrophobic to hydrophilic upon exposure to CO₂.

### BACKGROUND

Coatings and paints are routinely used to beautify and protect substrates. The most simple coatings and paints are made of a polymer (the binder) in a solvent (the vehicle). Paints and coatings modify the appearance of an object by adding color, gloss, or texture, and by blending with or differentiating from a surrounding environment. For example, a surface that is highly light scattering (that is, a flat surface) can be made glossy by the application of a paint that has a high gloss. Conversely, a glossy surface can be made to appear flat. Thus, the painted surface is hidden, altered, and ultimately changed in some manner by the presence of the coating. In addition, paints also protect the surface from the surrounding elements and prevent or reduce the corrosive process.

Paints and coatings, while protecting the substrate from external environment, can themselves get dirty. The dirt can dull the coating by increasing the light scattering or by modifying the color of the coating. The dirt can also affect the durability of a paint. There remains a need to develop coatings with hydrophilic surface and self-cleaning properties. A hydrophilic surface would allow water to spread out in a thin pool, sweeping dirt off the surface as the water puddles or thins out and trickles away. This type of “self-cleaning” behavior is advantageous to an exterior paint, as it keeps the coating clean without requiring extensive cleaning by the customer. A hydrophilic surface would allow water to sheathe over the surface and either solvate or even carry away the dirt molecules.

The hydrophilicity or hydrophobicity of a solid surface is commonly determined by contact angle (CA) measurements. For a liquid on a flat surface, the contact angle is considered to be the result of three different types of surface tension at the solid/liquid/gas interface, which is given by Young's equation. Based on Young's equation, hydrophilicity refers to a contact angle less than 90° on solid surfaces, while hydrophobicity refers to a contact angle higher than 90°. If the contact angle is less than 10°, the surface is often designated as super hydrophilic, provided that the surface do not absorb, react or dissolve in the water.

### SUMMARY

The present disclosure provides paints and coatings that change the coated surface from hydrophobic to a hydrophilic, self-cleaning surface when exposed to atmospheric CO₂. In one embodiment, a coating composition may include a polymer having at least one functional group selected from guanidinyl, amidinyl, hydroxyalkylaminoalkyl, dihydroxyalkylamino alkyl, or any combination thereof, wherein the at least one functional group on a surface of the polymer is configured to react with carbon dioxide to form a hydrophilic polymer coating.

In an additional embodiment, a method of coating a substrate may involve applying a coating to the substrate, wherein the coating includes a polymer having at least one functional group selected from guanidinyl, amidinyl, hydroxyalkylamino alkyl, dihydroxyalkylamino alkyl, or any combination thereof, and wherein the at least one functional group on a surface of the polymer is configured to react with carbon dioxide to form a hydrophilic polymer coating.

In a further embodiment, a coated article may be an article and a coating covering at least a portion of the article, wherein the coating includes a polymer having at least one functional group selected from guanidinyl, amidinyl, hydroxyalkylamino alkyl, dihydroxyalkylamino alkyl, or any combination thereof, and wherein the at least one functional group on a surface of the polymer is configured to react with carbon dioxide to form a hydrophilic polymer coating.

In another embodiment, a method of preparing a hydrophilic coating may include: providing a polymer having at least one functional group selected from guanidinyl, amidinyl, hydroxyalkylamino alkyl, dihydroxyalkylamino alkyl, or any combination thereof; and mixing the polymer with a solvent, a pigment, a coalescing agent, a rheology modifier, a plasticizer, a surfactant, or any combination thereof to form the hydrophilic coating.

### BRIEF DESCRIPTION OF THE FIGURES

FIG. 1 illustrates a polymer with amidinyl functional group according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

“Hydroxyalkylaminoalkyl” refers to functional groups of the general structure OH-(alkylene)-NH-(alkylene)-, wherein “alkylene” refers to a bivalent alkyl moiety having the general formula —(CH₂)ₙ₋, where n is from 1 to 25, 1 to 20, or 4 to 20. “Bivalent” means that the group has two open sites each of which bonds to another group. Examples of hydroxyalkylamin-oalkyl functional groups include hydroxymethyl- aminoethyl, hydroxyethylaminoethyl, hydroxy-ethylaminoisobutyl, and the like.

“Dihydroxyalkylamino alkyl” refers to functional groups of the general structure [OH-(alkylene)]₂-N-(alkylene)- . Examples of such functional groups include dihydroxymethyl-aminoethyl, dihydroxymethylaminoisopropyl, dihydroxymethylamino-n-butyl acrylate, N-hydroxymethyl-N-hydroxyethylaminoethyl, and the like.

“Alkyl” refers to a saturated hydrocarbon group which is straight-chained or branched. An alkyl group can contain from 1 to 20 carbon atoms, from 2 to 20 carbon atoms, from 1 to 10 carbon atoms, from 2 to 10 carbon atoms, from 1 to 8 carbon atoms, from 2 to 8 carbon atoms, from 1 to 6 carbon atoms, from 2 to 6 carbon atoms, from 1 to 4 carbon atoms, from 2 to 4 carbon atoms, from 1 to 3 carbon atoms, or 2 or 3 carbon atoms. Examples of alkyl groups include, but are not limited to, methyl (Me), ethyl (Et), propyl (example, n-propyl and isopropyl), butyl (example, n-butyl, t-butyl, isobutyl), pentyl (example, n-pentyl, isopentyl, neopentyl), hexyl, isohexyl, heptyl, 4,4 dimethylpentyl, octyl, 2,2,4-trimethylpentyl, nonyl, decyl, undecyl, dodecyl, 2-methyl-1-propyl, 2-methyl-2-propyl, 2-methyl-1-butyl, 3-methyl-1-butyl, 2-methyl-3-butyl, 2-methyl-l-pentyl, 2,2-dimethyl-1-propyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, and the like.

The present disclosure provides hydrophobic polymer emulsions with a hydrophilic surface that is self-cleaning. The hydrophobic polymer(s) may react with atmospheric CO₂ to form zwitterionic or polyelectrolytic functional groups, resulting in a hydrophilic and/or self-cleaning surface. The hydrophilic surface provides a large contact angle with water and helps water to sheath off, leaving it clean. The hydrophilic surface constantly renews itself as it is worn. In some embodiments, the coating composition may include a polymer having at least one functional group selected from guanidinyl, amidinyl, hydroxyalkylaminoalkyl, dihydroxyalkylamino alkyl, or any combination thereof, wherein the at least one functional group on a surface of the polymer is configured to react with carbon dioxide to form a hydrophilic polymer coating. In some embodiments, the functional group on the polymer may further include a hydroxyl group.

In some embodiments, the polymer may be a vinyl polymer, an acrylic polymer, a styrenic polymer, or any combination thereof. Non-limiting examples of polymers include polymers or copolymers of alkyl acrylate, alkyl methacrylate, allyl methacrylate, acrylic acid, methacrylic acid, acrylamide, 2-hydroxyethyl methacrylate, 2-hydroxypropyl methacrylate, thioethyl methacrylate, vinyl methacrylate, vinyl benzene, 2-hydroxyethyl acrylate, butyl acrylate, 2-ethylhexyl acrylate, vinyltrimethoxysilane, vinyltriethoxysilane, vinyl formate, vinyl acetate, vinyl propionate, vinyl butyrate, vinyl hexanoate, vinyltoluene, α-methyl styrene, chlorostyrene, styrenesulfonic acid, or any combination thereof.

In some embodiments, the monomeric units of the polymers described herein may contain pendant guanidinyl groups, and may be represented by the generic formula I:

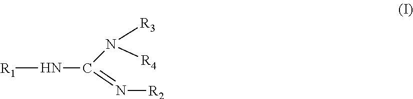

wherein, R₁ may be an acrylate monomer, a vinyl monomer or a styrene monomer described herein; and each R₂, R₃ and R₄ may be H or an alkyl group.

In some embodiments, the monomeric units of the polymers described herein may contain pendant amidinyl groups and may be represented by the generic formula II:

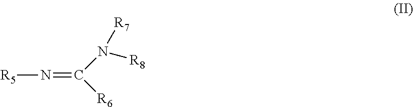

wherein, R₅ may be an acrylate monomer, a vinyl monomer or a styrene monomer described herein; and each R₆, R₇, and R₈ may be H or an alkyl group.

In some embodiments, monomeric units of the polymers described herein may contain hydroxyalkylaminoalkyl and dihydroxyalkylamino alkyl functional groups. The hydroxyalkylamino alkyl group may be represented by the general structure OH-(alkylene)-NH-(alkylene)-, and the dihydroxyalkylamino alkyl may be represented by the general structure [OH-(alkylene)]₂-N-(alkylene)- .

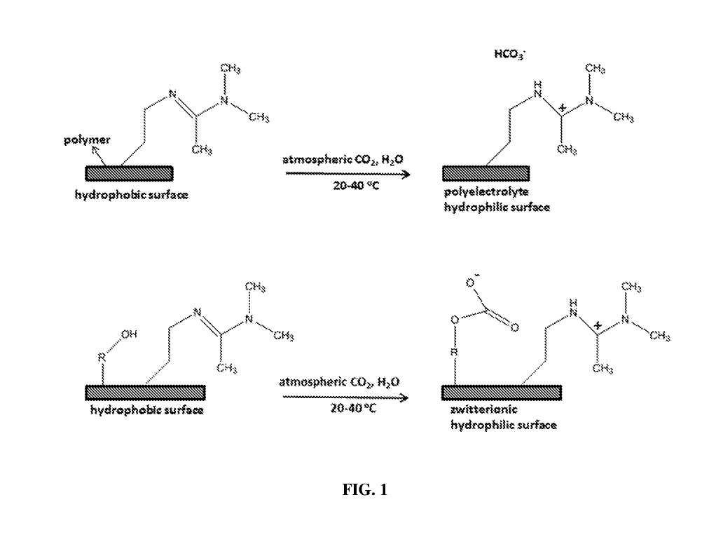

In some embodiments, the primary, secondary, and tertiary amino groups of compounds of formula I and formula II may react with CO₂ to form charged anionic groups, cationic groups, or a combination thereof. For example, an alkylguanidine may react with CO₂ in the presence of moisture to form alkyl carbamate, a polyelectrolyte. In some embodiments, the amidinyl groups and the adjacent hydroxyl groups on the polymer may react with CO₂ to form a zwitterion, as exemplified in FIG. 1. The polyelectrolytes or the zwitterions formed on the surface of the polymer may provide a hydrophilic surface to the coating.

In general, the reactions of primary/secondary amines with CO₂ may be represented by the following:

CO₂+RR′NH r′⇄RR′NH⁺COO³¹

RR′NH⁺COO⁻+RR′NH⇄RR′NH₂⁺

The reactions of tertiary amines with CO₂ may be represented as follows. Tertiary amines, in the presence of water, may combine with CO₂ to form:

CO₂+H₂O⇄H⁺+HCO₃—

Although the above described reactions are shown as being reversible, CO₂ desorption requires high temperature in the range of about 60° C. As a result, under ambient conditions usually having temperatures much lower than about 60° C., the coating surface may retain CO₂ to form ionic or polyelectrolyte groups, and display hydrophilic and self-cleaning properties.

In some embodiments, the hydroxyalkylaminoalkyl and dihydroxyalkylamino alkyl functional groups of the polymer may combine with CO₂ to form zwitterionic groups, thus giving rise to a hydrophilic surface. An exemplary reaction between diethanol amine and CO₂ is described below:

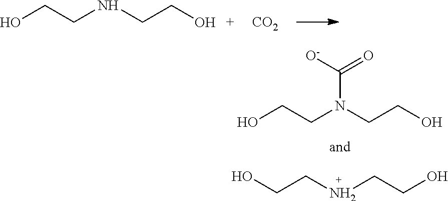

In some embodiments, a method of preparing a hydrophilic coating may include: providing a polymer comprising at least one functional group selected from guanidinyl, amidinyl, hydroxyalkylamino alkyl, dihydroxyalkylamino alkyl, or any combination thereof; and mixing the polymer with a solvent, a pigment, a coalescing agent, a rheology modifier, a plasticizer, a surfactant, or any combination thereof to form the hydrophilic coating.

In some embodiments, a polymer with guanidinyl or amidinyl functional groups may be prepared by reacting an acrylate polymer, a vinyl polymer, or a styrene polymer by methods known in the art. For example, a polymer with a chloride leaving group (poly(4-chloromethyl styrene) may be prepared by free radical polymerization techniques. Next, the polymer may be reacted with sodium azide, followed by the azide-alkyne Huisgen cycloaddition reaction in the presence of a Cu catalyst at room temperature to form an amidine-based polymer or a guanidine-based polymer.

In some embodiments, polymers with hydroxyalkylamino alkyl and dihydroxyalkylamino alkyl functional groups may be prepared by reacting an acrylate, a vinyl, or a styrene polymer with secondary and tertiary alkanolamines by methods known in the art. Non-limiting examples of the hydroxyalkylamino alkyl and dihydroxyalkylamino alkyl acrylate compounds that may be used in the coating compositions are N-hydroxymethylaminoethyl acrylate, N-hydroxyethylaminoethyl acrylate, N-hydroxyethylaminoisobutyl acrylate, N-hydroxy-t-butylaminoethyl acrylate, N,N-dihydroxymethylaminoethyl acrylate, N,N-dihydroxymethylaminoisopropyl acrylate, N,N-dihydroxymethylamino-n-butyl acrylate, N-hydroxymethyl-N-hydroxyethylaminoethyl acrylate, N,N-dihydroxyethylaminoethyl acrylate, N,N-dihydroxyisopropylaminoethyl acrylate, N,N-dihydroxy-n-propylamino-n-propyl acrylate, N,N-dihydroxy-n-propylaminoethyl acrylate, N,N-dihydroxy-n-butylamino-n-propyl acrylate, N-hydroxymethylaminoethyl methacrylate, N-hydroxyethylaminoethyl methacrylate, N-hydroxyethylaminoisobutyl methacrylate, N-hydroxy-t-butylaminoethyl methacrylate, N,N-dihydroxymethylaminoethyl methacrylate, N,N-dihydroxymethylaminoisopropyl methacrylate, N,N-dihydroxymethylamino-n-butyl methacrylate, N-hydroxymethyl-N-hydroxyethyl methacrylate, N,N-dihydroxyethylaminoethyl methacrylate, N,N-dihydroxyisopropylaminoethyl methacrylate, N,N-dihydroxy-n-propylamino-n-propyl methacrylate, N,N-dihydroxy-n-propylaminoethyl methacrylate, N,N-dihydroxy-n-butylamino-n-propyl methacrylate, and the like.

Paints and coatings may contain one or more additives in their composition. These additives may alter one or more of the properties of the paint, such as shelf life, application, longevity, and health and safety. Such additives may be added, for example, during the manufacture of the emulsion polymer or during the formulation of the paint itself. Additives include, but are not limited to, initiators, rheology modifiers, preservatives, coalescing agents, and the like. Initiators are a source of free radicals to initiate the polymerization process in which monomers condense to form the polymers. Coatings may contain a redox system initiator, such as ferrous and thiosulfate salts along with the persulfate salts, that promote polymerization at room temperature.

Thickeners and rheology modifiers may be also be added to coatings to achieve the desired viscosity and flow properties. Thickeners function by, for example, forming multiple hydrogen bonds with the acrylic polymers, thereby causing chain entanglement, looping and/or swelling, which results in volume restriction. Thickeners, such as cellulose derivatives including hydroxyethyl cellulose, methyl cellulose and carboxymethyl cellulose, may be used in the compositions.

One or more preservatives may be added in the coating compositions in low doses to protect against the growth of microorganisms. Preservatives, such as methyl benzisothiazolinones, chloromethylisothiazolinones, barium metaborate and 1-(3-chloroallyl)-3,5,7-triaza-1-azoniaadamantane chloride, may be used.

Coalescing agents, such as ester alcohols, benzoate ethers, glycol ethers, glycol ether esters and n-methyl-2-pyrrolidone, may be added to the coating compositions. Non-limiting examples of glycol ethers include ethylene glycol butyl ether, diethylene glycol butyl ether, triethylene glycol butyl ether, and any combinations thereof. Coalescing agents are added, for example, to promote film formation under varying atmospheric conditions. They may be slow evaporating solvents with some solubility in the polymer phase. They may also act as a temporary plasticizer, allowing film formation at temperatures below the system's glass transition temperature. After film formation, the coalescing agents may slowly diffuse to the surface and evaporate, increasing the hardness and block resistance of the film.

Coatings may further contain one or more of the following additives: solvents, pigments, plasticizers, surfactants, and the like. Surfactants may be used, for example, to create the micelles for particle formation, as well as long-term particle stabilization, to provide stability through electrostatic and steric hindrance mechanisms. Both ionic and non-ionic surfactants may be used. Examples may include, but are not limited to, alkyl phenol ethoxylates, sodium lauryl sulfate, dodecylbenzene sulfonate, polyoxyethylene alkyl ethers, polyoxyethylene alkyl allyl ethers, acetylene glycols, polyoxyethylene, stearic acid and polyoxypropylene.

One or more plasticizers may be added to the compositions to adjust the tensile properties of the paint film. Plasticizers include, for example, a glucose-based derivative, a glycerine-based derivative, propylene glycol, ethylene glycol, phthalates and the like.

Paints may further include one or more pigments. The term “pigments” is intended to embrace, without limitation, pigmentary compounds employed as colorants, including white pigments, as well as ingredients commonly known in the art as “opacifying agents” and “fillers”. Pigments may be any particulate organic or inorganic compound and may provide coatings with the ability to obscure a background of contrasting color (hiding power).

The present disclosure may relate to hydrophilic coating compositions that when applied to a substrate and cured, result in a hydrophilic coating. The hydrophilic surface may be due to formation of a cationic surface, an anionic surface, a polyelectrolytic surface, a zwitterionic surface, or a combination thereof, upon reacting with atmospheric CO₂. A hydrophilic coating composition may be a liquid hydrophilic coating composition, such as a solution or a dispersion comprising a liquid medium. Any liquid medium that allows application of the hydrophilic coating formulation on a surface would suffice. Examples of liquid media are alcohols, like methanol, ethanol, propanol, butanol, acetone, methylethyl ketone, tetrahydrofuran, dichloromethane, toluene, and aqueous mixtures or emulsions thereof, or water. The coating compositions of the present disclosure may be a latex emulsion, an aqueous solution, a non-aqueous solution, or a powder. The hydrophilic coating composition may further include components that when cured are converted into the hydrophilic coating, and thus remain in the hydrophilic coating after curing. As used herein, curing refers to physical or chemical hardening or solidifying by any method, such as heating, cooling, drying, crystallization or curing as a result of a chemical reaction, such as radiation-curing or heat-curing. In the cured state, all or a portion of the components in the hydrophilic coating formulation may be cross-linked forming covalent linkages between all or a portion of the components, such as by using UV or electron beam radiation. In addition, in the cured state, all or a portion of the components may be ionically bonded, bonded by dipole-dipole type interactions, or bonded via Van der Waals forces or hydrogen bonds.

To apply the hydrophilic coating on the substrate, a primer coating may be used in order to provide a binding between the hydrophilic coating and the substrate. In some instances, the primer coating facilitates adhesion of the hydrophilic coating to the substrate. The binding between the primer coating and the hydrophilic coating may occur due to covalent or ionic links, hydrogen bonding, or polymer entanglements. These primer coatings may be solvent-based, water-based (latexes or emulsions) or solvent-free and may include linear, branched and/or cross-linked components. Typical primer coatings that could be used may include, for example, polyether sulfones, polyurethanes, polyesters, polyacrylates, polyamides, polyethers, polyolefins, and copolymers thereof. The hydrophilic coatings of the present disclosure can also be applied on the substrate without a primer.

The coating of the present disclosure may be a decorative coating, an industrial coating, a protective coating, a self-cleaning coating, or any combination thereof. The coating of the present disclosure may generally be applied to any substrate. The substrate may be an article, an object, a vehicle, or a structure. Although no particular limitation is imposed on the substrate to be used in the present disclosure, exemplary substrates include, an exterior of a building, vehicles, cars, trucks, bicycles, bridges, airplanes, a hull of a boat or ship, metal railings, fences, glasses, plastics, metals, ceramics, wood, stone, cement, fabric, paper, leather, surfaces of swimming pools, spas, showers, bathtubs, sinks, ceramic and porcelain tile, plumbing, faucets, shower curtains, pipes, drains and sewers, electronics, automotive parts, marine parts, aerospace parts, and metal substrates. The coating may be applied to a substrate by any method, such as spraying, dipping, rolling, brushing, or any combination thereof.

An illustrative coating embodiment is depicted in FIG. 1. The film surface is hydrophobic in nature, but when exposed to atmospheric CO₂, the amidinyl groups and hydroxyl groups may react with CO₂ to form a polyelectrolytic and/or a zwitterionic surface. As the surface of the film is worn further, more hydrophilic groups are formed. Thus, the hydrophilic nature of the film's surface is renewed while the bulk of the film remains hydrophobic. The coatings can make it easier to clean objects and to preserve their original appearance, and can protect them from corrosion.

### EXAMPLES

### Example 1:

### Preparation of a Polymer with Amidinyl Functional Groups

Reversible Addition-Fragmentation chain Transfer (RAFT) Polymerization to make poly(4-chloromethylstyrene) (PCMS).

A mixture of 4-chloromethylstyrene (5.00 grams, 32.78 mmol), (S)-1-dodecyl-(S′)-(alpha, alpha′-dimethyl-alpha′-acetic acid)-trithiocarbonate (DDMAT) (238.00 milligrams, 0.656 mmol), 2,2′-azobis(isobutyronitrile) (AIBN) (21.50 milligrams, 0.131 mmol) and anisole (2.0 ml) are degassed by three freeze/thaw cycles, sealed under argon, and heated at 70° C. for 24 hours. The polymerization is stopped by immersing the reaction tube into liquid nitrogen for about 5 minutes. The product mixture is diluted with THF, and the final product is precipitated in n-hexane followed by filtration and drying under vacuum to give PCMS.

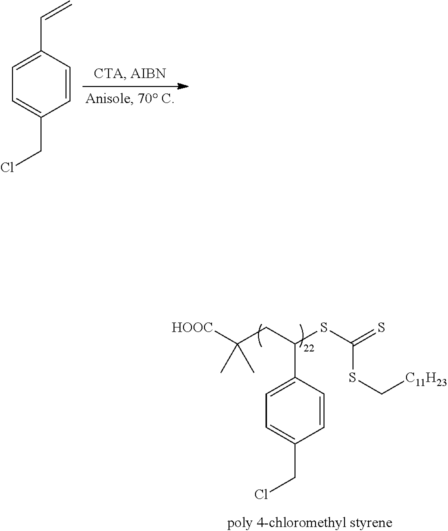

### Preparation of Poly(P-Azidomethylstyrene) (PAMS)

PCMS (2.00 grams, 0.54 mmol) is dissolved in 30 ml dry DMF followed by addition of NaN₃ (3.86 grams, 65.50 mmol). The reaction mixture is stirred at room temperature for 2 days and then precipitated in excess of methanol. The obtained product is re-dissolved in dichloromethane and re-precipitated in methanol. The resultant solid is collected by filtration and dried in a vacuum oven for 24 hours to give PAMS.

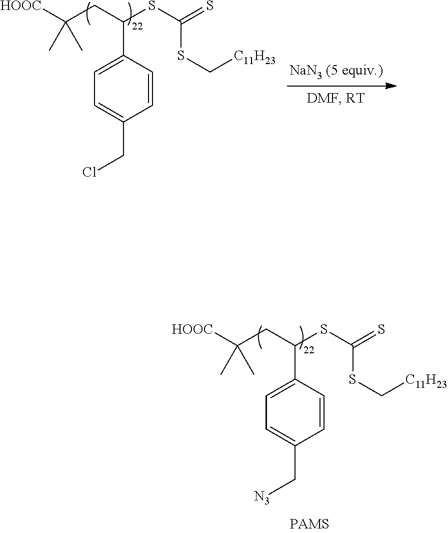

### Preparation of N′-Propargyl-N,N-Dimethylacetamidines (PDAA)

N,N-dimethylacetamide dimethyl acetal (2.00 grams, 15.00 mmol) and propargylamine (0.82 grams, 15.00 mmol) are added to a solution of CH₃CN (8.0 mL). The reaction mixture is stirred under N₂ at 65° C. for 1.5 hours. After removal of the solvent, the crude product is purified by chromatography to give the final compound PDAA, and is stored under argon.

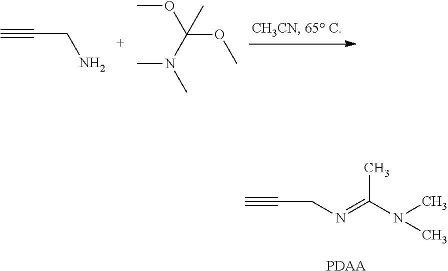

### Preparation of Amidine-Based Polymer by “Click” Reaction

To a solution mixture of PAMS (1.00 grams, 0.26 mmol) and PDAA (1.30 grams, 10.50 mmol) in 20 ml DMF, the catalyst CuBr (1.22 grams, 8.50 mmol) and N,N,N′N″N″-pentamethyldiethylenetriamine (PMDETA) (1.47 grams, 8.50 mmol) are added. The reaction vessel is sealed, and the mixture is degassed by freeze-pump-thaw cycles. The solution is stirred under argon at room temperature overnight. At the end of this period, the polymer solution is passed through a basic alumina column several times to remove copper salt. The polymer solution is precipitated into ether, filtered and dried in a vacuum oven to obtain a styrene polymer with amidinyl functional groups.

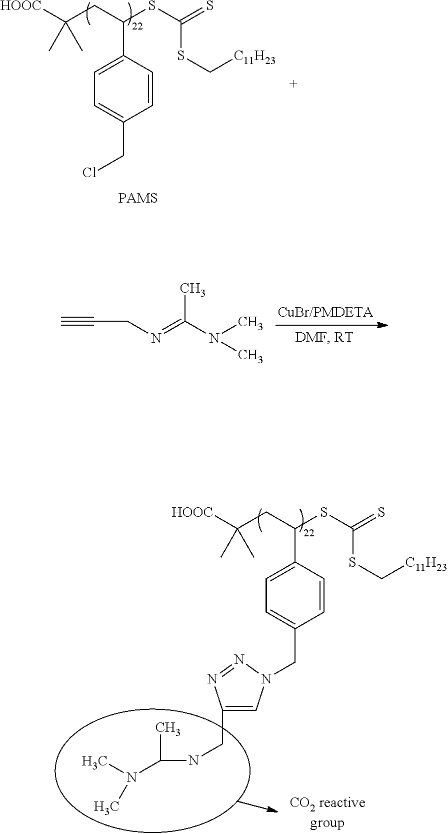

### Example 2

### Preparation of a Polymer with Guanidinyl Functional Groups

Poly(p-azidomethylstyrene) (PAMS) is prepared as in Example 1. To a solution mixture of PAMS and 1-(prop-2-ynyl)-guanidine, the catalyst CuBr (1.22 grams, 8.50 mmol) and N,N,N′N″N″-pentamethyldiethylenetriamine (PMDETA) (1.47 grams, 8.50 mmol) are added. The reaction vessel is sealed, and the mixture is degassed by freeze-pump-thaw cycles. The solution is stirred under argon at room temperature overnight. At the end of this period, the polymer solution is passed through a basic alumina column several times to remove copper salt. The polymer solution is precipitated into ether, filtered and dried in a vacuum oven to obtain a styrene polymer with guanidinyl functional groups.

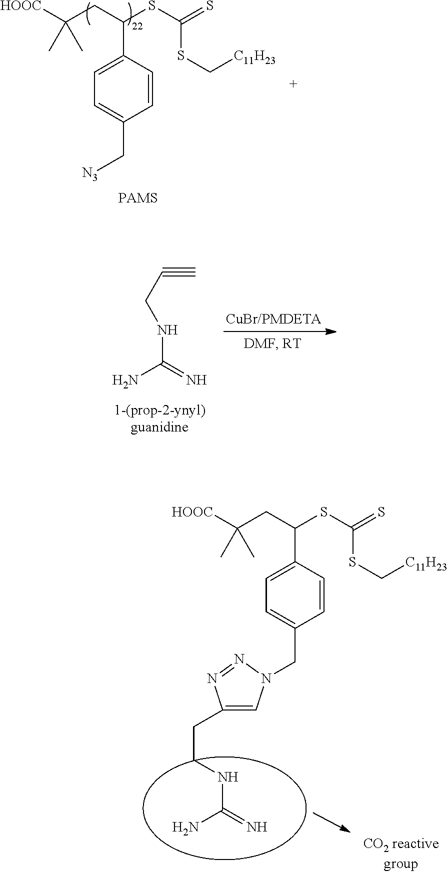

### Example 3

### Preparation of a Paint Composition

About 70 grams (25.70 weight percent) of the polymer of Example 1 is mixed with 40 grams of TiO₂ (14.68 weight percent), 2 grams of thickener (hydroxyethyl cellulose, 0.73 weight percent), 150 grams of solvent (water, 55.076 weight percent), 0.3 grams of coalescing agent (2,2,4-trimethyl-1,3-pentanediolmono(2-methylpropanoate))(0,110 weight percent), and 0.05 grams of bactericide (0.018 weight percent). The components are mixed under high shear for 30 minutes.

### Example 4

### Evaluation of Hydrophilic Property of a Coating

The paint composition of Example 3 is coated on a glass surface and dried at room temperature. The coated surface is exposed to CO₂ overnight, and the surface free energy and the water droplet contact angle of the hydrophilic coating are measured as follows. A Zisman plotting method is employed for measuring the surface free energy. The surface tension of various concentrations of an aqueous solution of magnesium chloride is plotted along the X-axis, and the contact angle in terms of cos θ is plotted along the Y-axis. A graph with a linear relationship between the two is obtained. The graph is extrapolated such that the surface tension at contact angle 0° is measured and is defined as the surface free energy of the coated glass surface. The surface free energy of the glass surface measured will be more than 85 milliNewton/meter. The high surface free energy is indicative of the hydrophilic property of the coating.

### Example 5

### Evaluation of Hydrophilic Coating

A coating composition of Example 3 is coated on a glass substrate and exposed to CO₂ overnight. The coating is evaluated for the following properties.

Hydrophilicity: The water droplet contact angle in air is measured by using DropMaster 500 (Kyowa Interface Science Co., Ltd). The water droplet contact angle measured will be 7°. The low water droplet contact angle is indicative of the hydrophilic property of the coating.

Water resistance and Durability: The hydrophilic coating is subjected to a rubbing treatment with sponge in 10 reciprocations in water while applying a load of 1 kg. The amount of residual film is calculated from a change of weight before and after the rubbing treatment. The weight of the film after the rubbing treatment will be 97% of the initial weight.

Weather resistance: The hydrophilic coating is exposed in a chamber to a xenon arc lamp that is calibrated to mimic the sun spectral characteristics (Atlas Sun Test). The exposure is performed for 500 hours and evaluated with respect to hydrophilicity, water resistance and durability. The hydrophilic coating will exhibit the same properties before and after the exposure.

### Example 6

### An object Coated With Hydrophilic Paint

A metal table is painted with a coating composition of Example 3 and is allowed to dry at room temperature. The table is exposed to CO₂ overnight. The anti-fouling property of the coating is measured as follows. A line is drawn on the coated table using oily ink. A similar line is also drawn on a table which is not coated. A water jet is continuously applied on both the surfaces and periodically checked whether the oily line is erased. The oily ink applied on the coated table will be erased after 1 minute whereas the oily line on the uncoated table will be un-changed and visible.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A coating composition comprising:
a polymer comprising at least one functional group selected from the group consisting of guanidinyl, amidinyl, hydroxyalkylaminoalkyl and dihydroxyalkylamino alkyl, wherein the at least one functional group on a surface of the polymer is configured to react with carbon dioxide to form a hydrophilic polymer coating.

2. The coating composition of claim 1, wherein the polymer is a vinyl polymer, an acrylic polymer, a styrenic polymer, or any combination thereof.

3. The coating composition of claim 1, wherein the polymer is a polymer or a copolymer of alkyl acrylate, alkyl methacrylate, allyl methacrylate, acrylic acid, methacrylic acid, acrylamide, 2-hydroxyethyl methacrylate, 2-hydroxypropyl methacrylate, thioethyl methacrylate, vinyl methacrylate, vinyl benzene, 2-hydroxyethyl acrylate, butyl acrylate, 2-ethylhexyl acrylate, vinyltrimethoxysilane, vinyltriethoxysilane, vinyl formate, vinyl acetate, vinyl propionate, vinyl butyrate, vinyl hexanoate, vinyltoluene, α-methyl styrene, chlorostyrene, styrenesulfonic acid, or any combination thereof.

4. The coating composition of claim 1, wherein the polymer further comprises at least one hydroxyl functional group.

5. The coating composition of claim 1, further comprising a solvent, a pigment, a coalescing agent, a rheology modifier, a plasticizer, a surfactant, or any combination thereof.

6. The coating composition of claim 1, wherein the coating composition is a latex emulsion, a non-aqueous dispersion, a powder, or any combination thereof.

7. The coating composition of claim 1, wherein the coating is a decorative coating, an industrial coating, a protective coating, a biocidal coating, or any combination thereof.

8. The coating composition of claim 1, wherein the coating is a self-cleaning coating.

9. A method of providing a zwitterionic surface, a cationic surface, or both, the method comprising:
applying a coating to a surface, wherein the coating comprises a polymer comprising at least one hydroxyl group and at least one functional group selected from the group consisting of guanidnyl, amidinyl, hydroxyalkylamino alkyl and dihydroxyalkylamino alkyl,
wherein the hydroxyl group and the functional group are configured to react with carbon dioxide to form the zwitterionic surface, the cationic surface, or both.

10. The method of claim 9, wherein applying a coating comprises applying a coating comprising a polymer having a vinyl polymer, an acrylic polymer, a styrenic polymer, or any combination thereof.

11. The method of claim 9, wherein applying a coating comprises applying a coating comprising a polymer or a copolymer of alkyl acrylate, alkyl methacrylate, allyl methacrylate, acrylic acid, methacrylic acid, acrylamide, 2-hydroxyethyl methacrylate, 2-hydroxypropyl methacrylate, thioethyl methacrylate, vinyl methacrylate, vinyl benzene, 2-hydroxyethyl acrylate, butyl acrylate, 2-ethylhexyl acrylate, vinyltrimethoxysilane, vinyltriethoxysilane, vinyl formate, vinyl acetate, vinyl propionate, vinyl butyrate, vinyl hexanoate, vinyltoluene, α-methyl styrene, chlorostyrene, styrenesulfonic acid, or any combination thereof.

12. The method of claim 9, wherein applying a coating comprises applying a coating further comprising a solvent, a pigment, a coalescing agent, a rheology modifier, a plasticizer, a surfactant, or any combination thereof.

13. The method of claim 9, wherein applying a coating comprises applying the coating in the form of a latex emulsion, a non-aqueous dispersion, a powder, or any combination thereof.

14. The method of claim 9, wherein applying a coating comprises applying the coating as a decorative coating, an industrial coating, a protective coating, a biocidal coating, or any combination thereof.

15. The method of claim 9, wherein applying a coating comprises applying the coating as a hydrophilic coating, a self-cleaning coating, or both.

16. The method of claim 9, wherein applying the coating to the surface comprises applying the coating by brushing, spraying, spreading, or rolling.

17. A method of coating a substrate, the method comprising:
applying a coating to the substrate, wherein the coating comprises a polymer comprising at least one functional group selected from the group consisting of guanidinyl, amidinyl, hydroxyalkylamino alkyl and dihydroxyalkylamino alkyl,
wherein the at least one functional group on a surface of the polymer is configured to react with carbon dioxide to form a hydrophilic polymer coating.

18. The method of claim 17, wherein applying a coating to the substrate comprises applying a coating comprising a polymer comprising a vinyl polymer, an acrylic polymer, a styrenic polymer, or any combination thereof.

19. The method of claim 17, wherein applying a coating to the substrate comprises applying a coating comprising a polymer or a copolymer of alkyl acrylate, alkyl methacrylate, allyl methacrylate, acrylic acid, methacrylic acid, acrylamide, 2-hydroxyethyl methacrylate, 2-hydroxypropyl methacrylate, thioethyl methacrylate, vinyl methacrylate, vinyl benzene, 2-hydroxyethyl acrylate, butyl acrylate, 2-ethylhexyl acrylate, vinyltrimethoxysilane, vinyltriethoxysilane, vinyl formate, vinyl acetate, vinyl propionate, vinyl butyrate, vinyl hexanoate, vinyltoluene, α-methyl styrene, chlorostyrene, styrenesulfonic acid, or any combination thereof.

20. The method of claim 17, wherein a coating to the substrate comprises applying a coating further comprising a solvent, a pigment, a coalescing agent, a rheology modifier, a plasticizer, a surfactant, or any combination thereof.

21. The method of claim 17, wherein applying a coating to the substrate comprises applying a coating in the form of a latex emulsion, a non-aqueous dispersion, a powder, or any combination thereof.

22. The method of claim 17, wherein applying a coating to the substrate comprises applying the coating as a decorative coating, an industrial coating, a protective coating, a biocidal coating, or any combination thereof.

23. The method of claim 17, wherein applying the coating to the substrate comprises applying is a self-cleaning coating.

24. The method of claim 17, wherein applying the coating to the surface comprises applying the coating by brushing, spraying, spreading, or rolling.

25.-38. (canceled)
